(19) United States
(12) Patent Application Publication
(10) Pub. No.: US 2025/0238558 A1
(43) Pub. Date: Jul. 24, 2025

(54) SYSTEM AND METHOD FOR SECURE CLOUD FPGA DEPLOYMENT USING A CERTIFICATE AUTHORITY AND ROOTS OF TRUST

(71) Applicant: University of Florida Research Foundation, Incorporated, Gainesville, FL (US)

(72) Inventors: Christophe Bobda, Gainesville, FL (US); Shuo Wang, Gainesville, FL (US); Maximillian Kealoha Panoff, Gainesville, FL (US); Muhammed Kawser Ahmed, Gainesville, FL (US)

(21) Appl. No.: 18/979,118

(22) Filed: Dec. 12, 2024

Related U.S. Application Data
(60) Provisional application No. 63/624,558, filed on Jan. 24, 2024.

(51) Int. Cl. G06F 21/75; G06F 21/57; G06F 21/64

(52) U.S. Cl. CPC G06F 21/75; G06F 21/575; G06F 21/64

(57) ABSTRACT

A method and system are directed to protecting a hardware design against confidentiality and integrity attacks, the method comprising providing a bootable image (BI) to a tenant computing entity; receiving a certificate chain originating from the tenant computing entity via the BI; validating the certificate chain with a certificate authority; providing a design rule data object to the tenant computing entity via the BI; receiving an secure design rule result data object and an encrypted bitstream; determining a match of the secure design rule result data object with the design rule data object; and programming a cloud programmable logic instance with a decryption of the encrypted bitstream based at least in part on the match.

### CROSS REFERENCE TO RELATED APPLICATION

This application claims the priority of U.S. Provisional Application No. 63/624,558, entitled “SYSTEM AND METHOD FOR SECURE CLOUD FPGA DEPLOYMENT USING A CERTIFICATE AUTHORITY AND ROOTS OF TRUST,” filed on Jan. 24, 2024, the disclosure of which is hereby incorporated by reference in its entirety.

### GOVERNMENT SUPPORT

This invention was made with government support under 2007320 awarded by The National Science Foundation and 1801599 awarded by The National Science Foundation. The government has certain rights in the invention.

### TECHNICAL FIELD

Various embodiments of the present disclosure relate to cloud-based hardware acceleration, and more particularly to secure cloud deployment of field-programmable gate array (FPGA) assets.

### BACKGROUND

Field-programmable gate arrays (FPGAs) may excel in handling large-scale search optimization, acceleration, and signal processing tasks when compared to CPUs in terms of power, latency, and processing speed. Cloud service providers can provide FPGA-based cloud acceleration services, allowing for customized acceleration with minimal power consumption. While providing FPGA computing as a cloud resource may provide several advantages over hardware FPGAs, several security concerns may arise. In particular, entire fabric sharing of a power distribution network allows hardware acceleration via cloud computing to become particularly vulnerable to remote physical side-channel attacks and voltage attacks by malicious actors. Furthermore, hardware assets deployed by tenants to cloud FPGA providers may contain sensitive information and intellectual property belonging to third-party vendors or the tenants themselves. For example, a malicious cloud provider may steal contents of a hardware design deployed on cloud FGPA and launch intellectual property counterfeiting, cloning, and/or piracy. Additionally, a malicious cloud provider may induce bitstream tampering that may result in information leakage and denial-of-service. Thus, there is a need for providing secure cloud FPGA between tenants and cloud FPGA providers.

### BRIEF SUMMARY

Various embodiments described herein relate to methods, apparatuses, and systems for protecting hardware intellectual property, particularly of cloud field-programmable gate array (FPGA) deployment.

According to one embodiment, the method comprises providing, by one or more processors, a bootable image (BI) to a tenant computing entity; receiving, by the one or more processors, a certificate chain originating from the tenant computing entity via the BI; validating, by the one or more processors, the certificate chain with a certificate authority; providing, by the one or more processors, a design rule data object to the tenant computing entity via the BI; receiving, by the one or more processors, an secure design rule result data object and an encrypted bitstream; determining, by the one or more processors, a match of the secure design rule result data object with the design rule data object; and programming, by the one or more processors, a cloud programmable logic instance with a decryption of the encrypted bitstream based at least in part on the match.

In some embodiments, the BI comprises an executable and one or more design compiling and design checking tools. In some embodiments, the tenant computing entity comprises a tenant-side root of trust (TSRoT). In some embodiments, the BI comprises a plurality of acceptable hash states that are associated with the TSRoT. In some embodiments, the TSRoT is configured to terminate execution of the BI based at least in part on the TSRoT comprising a hash state that is not in the plurality of acceptable hash states. In some embodiments, the cloud programmable logic instance comprises a cloud field-programmable gate array. In some embodiments, the method further comprises receiving a TSRoT certificate and a BI certificate; and validating the TSRoT certificate and the BI certificate with a certificate authority.

In some embodiments, the method further comprises generating the design rule data object by generating an encrypted design rule (EDR) nonce; and symmetrically encrypting a design rule with the EDR nonce. In some embodiments, the method further comprises generating an EDR key by asymmetrically encrypting the EDR nonce with a BI public key and a TSRoT public key. In some embodiments, the BI is configure to generate the encrypted bitstream by: determining the EDR nonce by asymmetrically decrypting the EDR key with a BI private key and a TSRoT private key; determining a design rule by symmetrically decrypting the design rule data object with the EDR key; extracting one or more design rule components from the design rule; generating a design rule result based at least in part on the one or more design rule components; generating a raw bitstream; generating a hash of the raw bitstream. In some embodiments, the BI is configured to generate the secure design rule result data object by determining an exclusive or (XOR) of a hash of the design rule result with a hash of the raw bitstream; and asymmetrically encrypting the XOR with a cloud programmable logic provider public key. In some embodiments, the BI is configured to generate the encrypted bitstream by applying a first symmetric encryption on the raw bitstream with the hash of the raw bitstream. In some embodiments, the BI is configured to generate the encrypted bitstream by applying a second symmetric encryption on the first symmetrically encrypted raw bitstream with a programmable logic-side root of trust nonce.

In some embodiments, the method further comprises determining the design rule result based at least in part on the secure design rule result data object by asymmetrically decrypting the secure design rule result data object with a cloud programmable logic provider private key. In some embodiments, the method further comprises recovering an estimate hash of the raw bitstream by generating an XOR of the design rule result and a hash of an expected design rule result. In some embodiments, the method further comprises recovering, using the programmable logic-side root of trust nonce, the first symmetrically encrypted raw bitstream by symmetrically decrypting the second symmetrically encrypted raw bitstream with the programmable logic-side root of trust nonce. In some embodiments, the method further comprises recovering, using the programmable logic-side root of trust nonce, the raw bitstream by symmetrically decrypting the recovered first symmetrically encrypted raw bitstream with the estimate hash of the raw bitstream. In some embodiments, determining the match of the secure design rule result data object with the design rule data object comprises comparing a hash of the recovered raw bitstream with the estimate hash of the raw bitstream.

In some embodiments, a system comprises one or more processors and at least one memory storing processor-executable instructions that, when executed by any of the one or more processors, causes the one or more processors to perform operations comprising providing a bootable image (BI) to a tenant computing entity; receiving a certificate chain originating from the tenant computing entity via the BI; validating the certificate chain with a certificate authority; providing a design rule data object to the tenant computing entity via the BI; receiving a secure design rule result data object and an encrypted bitstream; determining a match of the secure design rule result data object with the design rule data object; and programming a cloud programmable logic instance with a decryption of the encrypted bitstream based at least in part on the match.

In some embodiments, one or more non-transitory computer-readable storage media include instructions that, when executed by one or more processors, cause the one or more processors to perform operations comprising providing a bootable image (BI) to a tenant computing entity; receiving a certificate chain originating from the tenant computing entity via the BI; validating the certificate chain with a certificate authority; providing a design rule data object to the tenant computing entity via the BI; receiving a secure design rule result data object and an encrypted bitstream; determining the secure design rule result data object matches with the design rule data object; and programming a cloud programmable logic instance with a decryption of the encrypted bitstream based at least in part on the determination.

### BRIEF DESCRIPTION OF THE DRAWINGS

Embodiments incorporating teachings of the present disclosure are shown and described with respect to the figures presented herein.

FIG. 1 depicts an architecture in accordance with some embodiments of the present disclosure.

FIG. 2 depicts an example cloud FPGA provider computing entity in accordance with some embodiments of the present disclosure.

FIG. 3 depicts an example tenant computing entity in accordance with some embodiments of the present disclosure.

FIG. 4 is a data flow diagram of a secure cloud FPGA deployment platform in accordance with some embodiments of the present disclosure.

FIG. 5 is a flowchart diagram of an example secure cloud FPGA deployment process in accordance with some embodiments of the present disclosure.

FIG. 6 is a flowchart diagram of an example bitstream encryption process in accordance with some embodiments of the present disclosure.

FIG. 7 is an operational example of algorithms for performing BI methods in accordance with some embodiments of the present disclosure.

FIG. 8 is an operational example of an algorithm for implementing a DecryptStrapper and DLD in accordance with some embodiments of the present disclosure.

FIG. 9 is an operational example of an algorithm for deploying a raw bitstream to cloud programmable logic in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides systems and methods for safeguarding against different attacks on intellectual property (IP) confidentiality and integrity, particular of hardware designs in cloud field-programmable gate array (FPGA) deployment.

FPGAs are well-known for their ability to accelerate many current computational loads, such as for search requests and deep learning. As a result, cloud users, or tenants may integrate FPGA solutions into their architectures via cloud FPGA providers (CFPs). CFPs may offer FPGA-acceleration through the cloud, e.g., FPGA as a service, allowing users to program instances of cloud FPGA by uploading their designs. However, as FPGA designs create and connect physical hardware, they have unique security challenges associated with them in addition to those of traditional cloud computing.

For example, in a remote side channel analysis attack, a malicious user may upload a design to an FPGA that contains malicious circuitry such as ring oscillators and time/digital converters that may indirectly measure voltage on a circuit board. Such voltage data may be collected by the malicious user who can then analyze the voltage data to recover sensitive information from other circuits on the FPGA, such as keys used in (Rivest-Shamir-Adleman) RSA. Furthermore, deep learning may greatly increase the capabilities of such side channel attacks.

To mitigate risks associated with remote side channel analysis and other threats, CFPs may implement design rules and virus checkers to evaluate hardware designs to ensure no such malicious circuitry are made available to tenants. However, such checks are typically executed on designs created on CFP programs provided to tenants through the cloud. However, this naturally raises concerns of the confidentiality of designs that run on a system controlled by the CFP. Solutions to such concerns typically rely on Trusted Execution Environments (TEEs), such as TrustZone, to ensure confidentiality. However, TEEs often have limits on their throughput, with checks and compilation taking significantly longer on them.

According to various embodiments of the present disclosure, systems and methods for tenant-side checking of designs for cloud FPGA deployment are provided. The present application discloses two separate roots of trust (RoTs) and dually leveraged deployment (DLD) that serve as a set of checks and balances to (i) allow tenants to check their own designs and ensure that bitstreams compiled by tenants based at least in part on the designs are safe to be used in the cloud, without compromising the confidentiality of the design and (ii) enable CFPs to authenticate design rule results of bitstreams checked by the tenants.

The two separate RoTs may comprise (i) a tenant-side ROT (TSRoT) and (ii) a FPGA-side ROT (hereinafter referred to as a DecryptStrapper) associated with a cloud FPGA instance (e.g., a FPGA to program with a design). As such, a CFP may leverage a TSRoT to bootstrap trust onto a tenant's device and a tenant may leverage a DecryptStrapper on a target FPGA owned by the CFP to securely implement a design on the FPGA. The DecryptStrapper may authenticate results of an inspection for potential malicious circuitry performed by the tenant without the need for a dedicated TEE.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

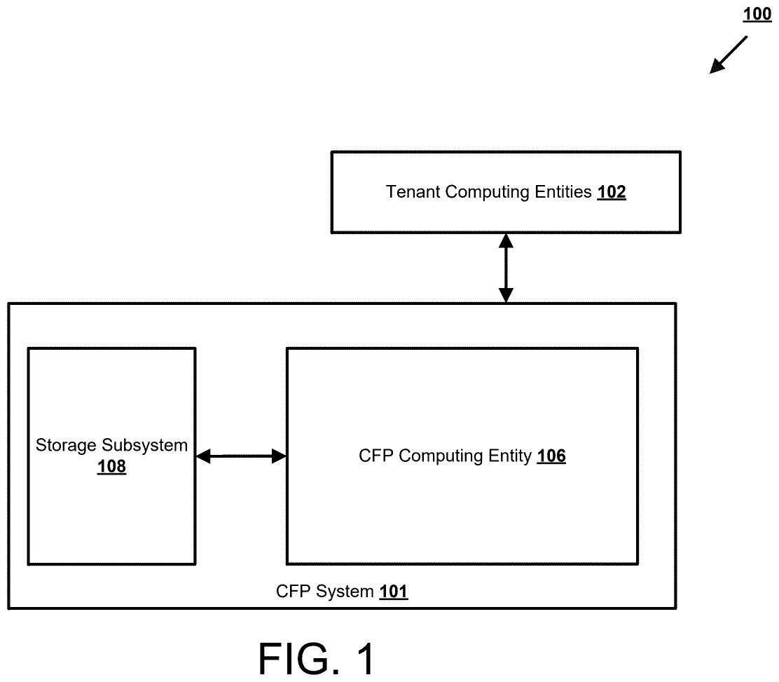

FIG. 1 depicts an architecture 100 in accordance with some embodiments of the present disclosure. The architecture 100 includes a CFP system 101 that may be configured to receive FPGA programming requests from tenant computing entities 102, process the FPGA programming requests to facilitate programming of cloud FPGA instances by the tenant computing entities 102. The CFP system 101 may generate a bootable image (BI) that comprises a minimal executable and one or more design compiling and design checking tools and provide the BI to the requesting one of the tenant computing entities 102. The CFP system 101 may be further configured to (i) receive a certificate chain from the one of the tenant computing entities 102 via the BI, (ii) validate the certificate chain with a CA, (iii) provide design rules to the one of the tenant computing entities 102 via the BI, (iv) receive an secure design rule result and an encrypted bitstream, and (v) program a cloud FPGA instance with a decryption of the encrypted bitstream based at least in part on the secure design rule result matching the design rules.

In some embodiments, CFP system 101 may communicate with at least one of the tenant computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The CFP system 101 may include a CFP computing entity 106 and a storage subsystem 108. The CFP computing entity 106 may be configured to receive FPGA programming requests from tenant computing entities 102, process the FPGA programming requests to facilitate programming of cloud FPGA instances by the tenant computing entities 102. The CFP computing entity 106 may generate a BI that comprises a minimal executable and one or more design compiling and design checking tools and provide the BI to the requesting one of the tenant computing entities 102. The CFP computing entity 106 may be further configured to (i) receive a certificate chain from the one of the tenant computing entities 102 via the BI, (ii) validate the certificate chain with a CA, (iii) provide design rules to the one of the tenant computing entities 102 via the BI, (iv) receive an secure design rule result and an encrypted bitstream, and (v) program a cloud FPGA instance with a decryption of the encrypted bitstream based at least in part on the secure design rule result matching the design rules.

The storage subsystem 108 may be configured to store input data used by the CFP computing entity 106 to perform checking and securing of hardware designs provided by tenant computing entities 102. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Example CFP Computing Entity

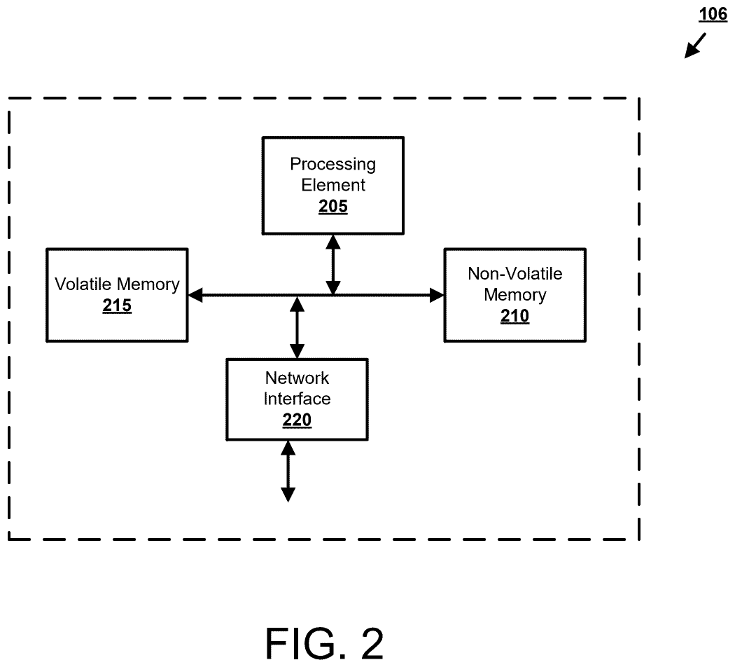

FIG. 2 depicts an example CFP computing entity 106 in accordance with some embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the CFP computing entity 106 may also include one or more network interfaces 220 for communicating with various computing entities, such as tenant computing entities 102.

As shown in FIG. 2, in one embodiment, the CFP computing entity 106 may include, or be in communication with, one or more processing elements 205 (also referred to as processors, processing circuitry, and/or similar terms used herein interchangeably) that communicate with other elements within the CFP computing entity 106 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the CFP computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the CFP computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the CFP computing entity 106 with the assistance of the processing elements 205 and operating system.

As indicated, in one embodiment, the CFP computing entity 106 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the CFP computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the CFP computing entity 106 may include, or be in communication with, one or more input elements, such as a keyboard input, a mouse input, a touch screen/display input, motion input, movement input, audio input, pointing device input, joystick input, keypad input, and/or the like. The CFP computing entity 106 may also include, or be in communication with, one or more output elements (not shown), such as audio output, video output, screen/display output, motion output, movement output, and/or the like.

### Example Tenant Computing Entity

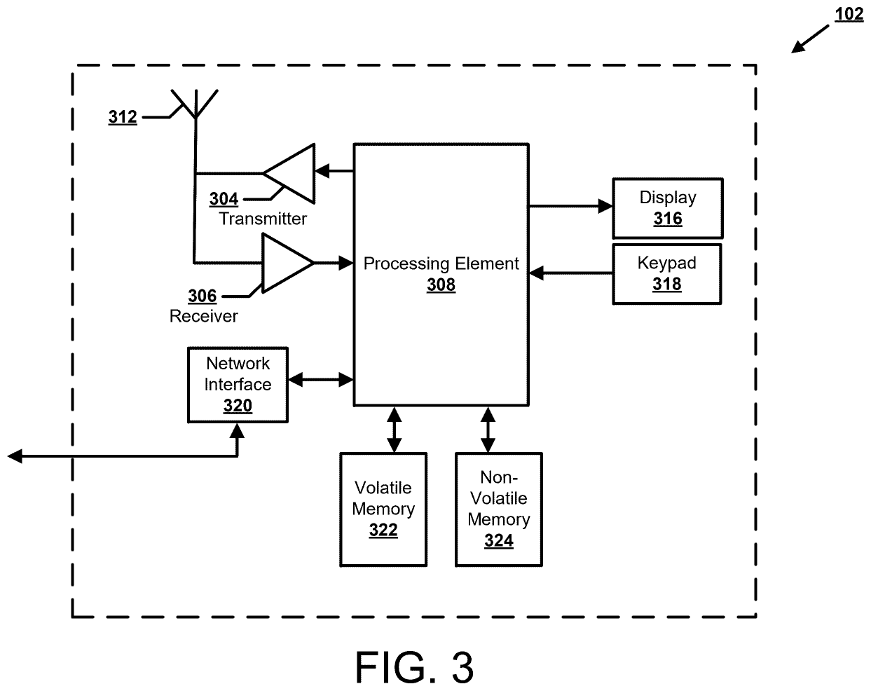

FIG. 3 depicts an example tenant computing entity 102 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Tenant computing entities 102 can be operated by various parties. As shown in FIG. 3, the tenant computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the tenant computing entity 102 may be capable of operating with one or more air interface standards, communication protocols, modulation types, and access types. More particularly, the tenant computing entity 102 may operate in accordance with any of a number of wireless communication standards and protocols, such as those described above. In a particular embodiment, the tenant computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the tenant computing entity 102 may operate in accordance with multiple wired communication standards and protocols, such as those described above via a network interface 320.

Via these communication standards and protocols, the tenant computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The tenant computing entity 102 can also download changes, add-ons, and updates, for instance, to its firmware, software (e.g., including executable instructions, applications, program modules), and operating system.

According to one embodiment, the tenant computing entity 102 may include location determining aspects, devices, modules, functionalities, and/or similar words used herein interchangeably. For example, the tenant computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the tenant computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The tenant computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the tenant computing entity 102 to interact with, access, and/or cause display or retrieval of information/data from the CFP computing entity 106, as described herein. The user input interface can comprise any of a number of devices or interfaces allowing the tenant computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the tenant computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The tenant computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the tenant computing entity 102. As indicated, this may include a user application that is resident on the tenant computing entity 102 or accessible through a browser or other user interface for communicating with the CFP computing entity 106 and/or various other computing entities.

In another embodiment, the tenant computing entity 102 may include one or more components or functionality that are the same or similar to those of the CFP computing entity 106, as described in greater detail above. As will be recognized, these architectures and descriptions are provided for exemplary purposes only and are not limiting to the various embodiments.

In various embodiments, the tenant computing entity 102 may be embodied as an artificial intelligence (AI) computing entity. Accordingly, the tenant computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example System Operations

Various embodiments of the present disclosure describe steps, operations, processes, methods, functions, and/or the like for securing hardware designs deployed in cloud FPGA environments. For example, CFPs may comprise cloud computing providers that offer FPGA computing resources as a cloud service to tenant computing entities. As such, tenants may conveniently apply FPGA-based hardware acceleration for specific applications by leveraging FPGA as a cloud service. Tenants may program cloud FPGA instances to execute their specific applications through the cloud by deploying hardware designs to the cloud FPGA instances.

Despite the many benefits provided by deploying FPGA computing through the cloud, threats to both tenants and CFPs may exist. For example, malicious circuitry/programming may be inserted by tenants into cloud FPGA instances allocated to the tenants, either knowingly or unknowingly, to carry out remote side channel or denial-of-service attacks. That is, tenants may introduce malicious circuitry in their designs that causes physical damage or breaches to the integrity or confidentiality of other designs that may also be deployed on a same cloud FPGA instance. To prevent this, CFPs may comprise design rule checks and virus scanners that may examine designs to ensure that malicious circuits are not included. However, if given foreknowledge of such checks that designs will be subjected to, malicious actors may be able to operate around those restrictions.

Furthermore, in order to run design rule checks, CFPs will traditionally require access to raw designs, which may raise concerns of confidentiality from the perspective of tenants. For example, CFPs may steal tenant designs to reuse or resell them, e.g., IP Piracy. Preventing designs from being seen by CFPs may go beyond confidentiality concerns. In particular, CFPs may add malicious circuitry to designs that affect performance during critical junctions. As such, tenants may desire that their designs are placed on a FPGA unmodified and unseen. Balancing design confidentiality with the CFP's need to detect malicious circuitry poses security and trust issues.

According to various embodiments of the present disclosure, systems and methods for establishing mutual trust between CFPs and tenants during cloud FPGA deployment are provided. The disclosed systems and methods may ensure that designs uploaded by tenants are safe to be deployed to cloud FPGA instances without compromising the confidentiality of the design. In some embodiments, CFPs may require tenants to inspect designs (e.g., for deployment to cloud FPGA instances) based at least in part on design rules which may detect malicious circuitry in a design along with other violations. To enable CFPs to authenticate design rule results provided by tenants, the CFPs may leverage TSRoTs to bootstrap trust onto the tenants' devices. At the same time, tenants may leverage DecryptStrappers associated with cloud FPGA instances that are allocated to the tenants by the CFPs to securely implement designs on the cloud FPGA instances. As such, tenants may be prevented from uploading falsified design rule results while avoiding exposing an unencrypted design to the CFP.

According to various embodiments of the present disclosure, a secured design rule result (SDRR) is generated by a tenant computing entity combining a hash of a compiled bitstream of a design with a hash of a design rule result or virus scan result. In some embodiments, programming a cloud FPGA instance comprises the tenant computing entity transmitting the SDRR along with an encrypted version of the bitstream that is encrypted by the tenant computing entity to a CFP computing entity. In some embodiments, the CFP computing entity recovers the hash chain of the bitstream and forwards the encrypted bitstream to a DecryptStrapper on the cloud FPGA instance. The DecryptStrapper checks the recovered hash chain against a recovered bitstream (from the encrypted bitstream) to confirm they match before programming the cloud FPGA instance with the bitstream.

In some embodiments, TSRoTs and DecryptStrappers comprise RoTs implemented on tenant computing entities (e.g., tenant computing entities 102) and cloud FPGA instances, respectively. In some embodiments, a RoT comprises a hardware, firmware, or software component that is configured to establish trust of all other components within a system. A RoT may also provide various security functions, such as secure key storage, attestation, secure communication, and cryptographic operations.

In some embodiments, a hash chain describes a cryptographic state of data that is generated based at least in part on a sequence of hash values. Each hash value may be computed by combining a previous hash value with a new hash value. Hash chains may be used in securing system operations. For example, a hash state may be compared to a list of known values stored in a secure location in a system. If the hash state matches a known value, the system may continue. If the hash state does not match a known value, it is assumed that the process has been compromised, and the system may be halted.

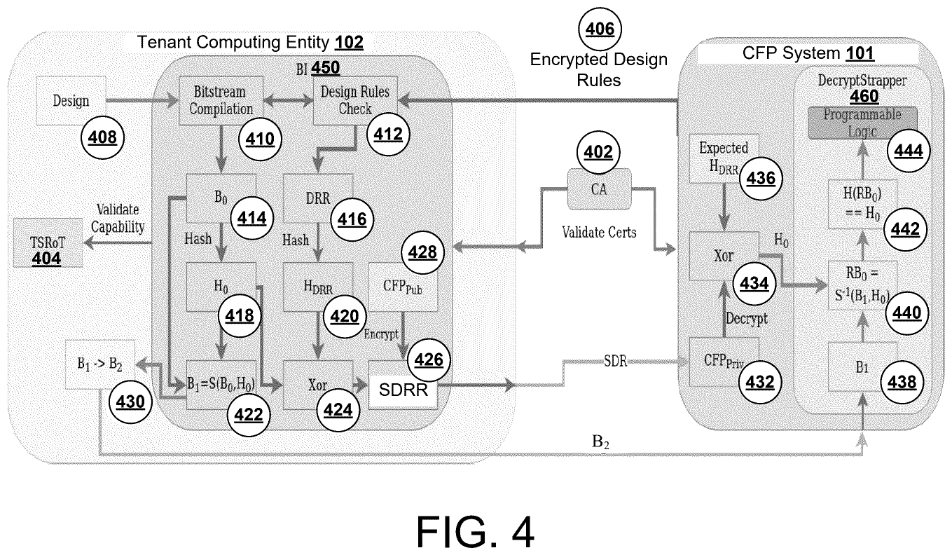

FIG. 4 is a data flow diagram of a secure cloud FPGA deployment platform in accordance with some embodiments of the present disclosure.

One of the one or more tenant computing entities 102 may request one or more cloud FPGA instances from CFP system 101. CFP system 101 may be configured to allocate a given one of the one or more cloud FPGA instances to the one or more tenant computing entities 102. One or more tenant computing entities 102 may be used by tenants to place a design on given one of the one or more cloud FPGA instances. The given one of the one or more cloud FPGA instances may comprise programmable logic 444 and a DecryptStrapper 460 that is configured to authenticate design rule results from one of tenant computing entities 102 allocated with the given cloud FPGA instance and allow for programming of programmable logic 444 (e.g., cloud FPGA instance) with a bitstream based at least in part on the design rule results. The CFP system 101 may also generate and provide a BI 450 to the tenant computing entity 102. The BI 450 may be used by the tenant computing entity 102 to compile bitstreams and check designs.

The tenant computing entity 102 comprises a TSRoT 404. The BI 450 may comprise an acceptable hash states (AHS) list encrypted for the TSRoT 404. In some embodiments, the TSRoT 404 is configured to shut down or terminate execution of the BI 450 should a hash state of the TSRoT 404 exit the list of allowed hash state values. In some embodiments, the BI 450 may require authentication of the TSRoT 404 in order to execute one or more functions. The BI 450 may generate a new private key at runtime, which is then registered with the TSRoT 404 to form a certificate chain. The signed certificate may then be provided to the CFP system 101, which uses it to create EDR 406 after verifying the creator is the BI 450.

In some embodiments, the BI 450 generates a BI public key (BI_{Pub}), a BI private key (BI_{Priv}), and a BI certificate (BI_{Cert}), and sends the BI_{Pub}, BI_{Priv}, and BI_{Cert} to TSRoT 404 to sign, thereby generating a TSRoT certificate (TSRoT_{Cert}) and a BI certificate (BI_{Cert}), which may be provided by the BI 450 to the CFP system 101. In some embodiments, the CFP system 101 is configured to receive the TSRoT certificate (TSRoT_{Cert}), the BI certificate (BI_{Cert}), an encrypted design rule request (EDR_{REQ}), and capabilities of the TSRoT 404. The CFP system 101 may validate the TSRoT Cert and the BI_{Cert} with a certification authority (CA) 402 to mitigate “man-in-the-middle” attacks between the CFP system 101 and TSRoT 404, particularly of design rules. In some embodiments, the CFP system 101 is configured to maintain a list of design rules that are used to determine design compliance and detect malicious circuitry. For example, should the tenant computing entity 102 recover the plaintext of design rules, design rule results may be extracted, and passing design rule results may be falsified for arbitrary bitstreams. As such, this may be prevented by CFP system 101 confirming TSRoT_{Cert} and BI_{Cert} with the CA 402.

In some embodiments, the CFP system 101 may provide a TSRoT public key (TSRoT_{Pub}) to the DecryptStrapper 460. In some embodiments, the DecryptStrapper 460 generates a DecryptStrapper nonce (N_{DS}). In some embodiments, an encrypted DecryptStrapper nonce N_{DS_Full} is generated based at least in part on the N_{DS}. In some embodiments, N_{DS_Full} comprises a vector including an N_{DS_Safe} and an N_{DS_Auth}. N_{DS_Safe} may be generated based at least in part on an asymmetric encryption of a DecryptStrapper nonce (N_{DS}) with the TSRoT_{Pub}. N_{DS_Auth} may be generated based at least in part on an asymmetric encryption of N_{DS_Safe} with a DecryptStrapper private key (DS_{Priv}).

In some embodiments, the CFP system 101 generates an encrypted design rules (EDR) 406, which the BI 450 may decrypt to recover design rules. In some embodiments, the EDR 406 is generated by (i) generating a EDR nonce (N_{EDR}) and (ii) and symmetrically encrypting one or more design rules with the N_{EDR}. Along with the EDR 406, the CFP system 101 may also return an EDR key (EDR_{Key}) and N_{DS_Full} to the BI 450. In some embodiments, the EDR_{Key} is generated by asymmetrically encrypting the N_{EDR} with the BI_{Pub} and further asymmetrically encrypting with the TSRoT_{Pub}.

The EDR 406, the EDR_{Key}, and the encrypted DecryptStrapper nonce (N_{DS_Full}) may be provided to the BI 450 to facilitate generating a raw bitstream B₀ 414. In some embodiments, raw bitstream B₀ 414 may is generated by the BI 450 based at least in part on a bitstream compilation 410 of a design 408. The BI 450 may also perform design rules check 412 on the design 408. A bitstream compilation 410 may be performed based at least in part on a design rule (DR), a register transfer language (RTL) of the design 408, and the EDR_{Key}. In some embodiments, bitstream compilation 410 comprises instructions for (i) determining the N_{EDR} by asymmetrically decrypting the EDR_{Key} with the BI_{Priv} and a TSRoT private key (TSRoT_{Priv}), (ii) determining DR by symmetrically decrypting the EDR 406 with the EDR_{Key}, (iii) extracting DR_{RTL}, DR_{Syn}, DR_{Impl}, and DR_{Bit} from the DR, (iv) generating design rule result (DDR) 416 based at least in part on the DR_{RTL}, the DR_{Syn}, the DR_{Impl}, and the DR_{Bit}, (v) generating the raw bitstream B₀ 414, (vi) generating a hash H₀ 418 of the raw bitstream B₀ 414, (vii) generating a secure design rule result (SDRR) 426, and (viii) generating a first encrypted bitstream B₁ 422.

DDR416 may comprise a vector including DRR₁, DRR₂, DRR₃, and DRR₄. In some embodiments, generating DDR416 comprises (i) generating DRR₁ by performing design rules check 412 on the RTL based at least in part on the DR_{RTL}, (ii) generating a synthesis based at least in part on the RTL, (iii) generating DRR₂ by performing design rules check 412 on the synthesis of the RTL based at least in part on the DR_{syn}, (iv) generating an implementation based at least in part on the synthesis, (v) generating DRR₃ by performing design rules check 412 on the implementation of the synthesis based at least in part on the DR_{Impl}, (vi) generating raw bitstream B₀ 414 based at least in part on the implementation, and (vii) generating DRR₄ by performing design rules check 412 on the raw bitstream B₀ 414 based at least in part on the DR_{Bit}.

In some embodiments, generating the SDRR 426 comprises (a) determining an exclusive or (XOR) 424 of a hash H_{DRR} 420 of DRR 416 with hash H₀ 418 of the raw bitstream B₀ 414 and (b) asymmetrically encrypting the XOR 424 with a CFP public key (CFP_{PubKey}) 428. In some embodiments, generating the first encrypted bitstream B₁ 422 comprises symmetrically encrypting the raw bitstream B₀ 414 with the hash H₀ 418.

In some embodiments, the tenant computing entity 102 verifies DecryptStrapper certificate (DS_{Cert}) with the CA 402 to prevent against man-in-the-middle attacks of encrypted bitstreams. In some embodiments, the tenant computing entity 102 recovers \hat{N}_{DS}. by asymmetrically decrypting N_{DS_Safe} with TSRoT_{Priv}. In some embodiments, the tenant computing entity 102 confirms that the asymmetric decryption of N_{DS_Auth} with DecryptStrapper public key (DS_{pub}) and TSRoT_{Priv} matches the recovered \hat{N}_{DS}.

The tenant computing entity 102 further generates an encrypted bitstream B₂ 430 based at least in part on the first encrypted bitstream B₁ 422. In some embodiments, generating encrypted bitstream B₂ 430 comprises symmetrically encrypting the first encrypted bitstream B₁ 422 with the recovered \hat{N}_{DS}. The SDRR 426 and encrypted bitstream B₂ 430 are then sent to the CFP system 101 to initiate deployment.

CFP system 101 may determine DRR 416 from SDRR 426 by asymmetrically decrypting SDRR 426 with CFP private key (CFP_{Priv}) 432. The CFP system 101 may then recover an estimate hash of B₀, Ĥ₀, by generating an XOR 434 of the DRR 416 (from SDRR 426) and a hash of an expected design rule result (H_{DRR}) 436. The encrypted bitstream B₂ 430 and Ĥ₀ may be provided to DecryptStrapper 460 by the CFP system 101. In some embodiments, the DecryptStrapper 460 recovers encrypted bitstream \hat{B}₁ 438 by symmetrically decrypting B₂ with N_{DS}. In some embodiments, the DecryptStrapper 460 may then recover bitstream \hat{B}₀ 440 by symmetrically decrypting recovered encrypted bitstream \hat{B}₁ 438 with Ĥ₀.

DecryptStrapper 460 generates a comparison 442 between a hash of recovered bitstream \hat{B}₀ 440 and Ĥ₀. Should there be any malicious circuitry in the RTL code provided to the BI 450 by the tenant computing entity 102, the DRR 416 will differ from the H_{DRR} 436. As a result, the Ĥ₀ of the DRR 416 will be different from the hash of recovered bitstream \hat{B}₀ 440. Thus, when the SDRR 426 is used to obtain Ĥ₀, the resulting value will be incorrect and the hash of the recovered bitstream \hat{B}₀ 440 will not match Ĥ₀. On the other hand, if all or a pre-requisite of rules in the design rules were followed or violated as expected by the CFP, the hash of recovered bitstream \hat{B}₀ 440 will equal to Ĥ₀. In the event that the hash of recovered bitstream \hat{B}₀ 440 does not match Ĥ₀, the DecryptStrapper 460 may refuse to program the programmable logic 444 and alert the CFP system 101. If the comparison 442 of a hash of recovered bitstream \hat{B}₀ 440 is equal to Ĥ₀, the DecryptStrapper 460 programs programmable logic 444 with the recovered \hat{B}₀ 440.

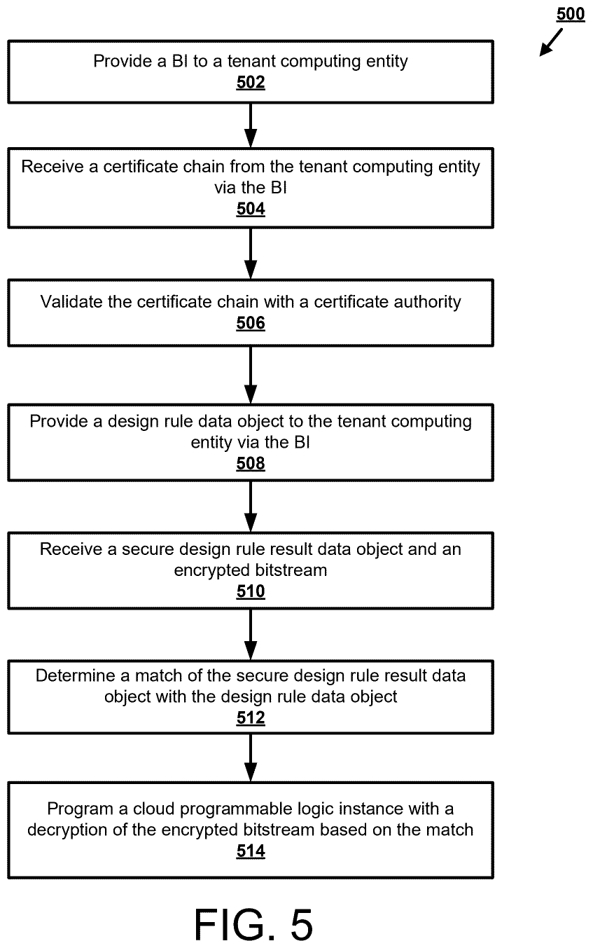

FIG. 5 is a flowchart diagram of an example secure cloud FPGA deployment process 500 in accordance with some embodiments of the present disclosure. The flowchart diagram depicts a DLD technique for deploying a hardware design on cloud FPGA that establishes trust between all parties of the cloud FPGA deployment (e.g., a tenant and a provider), thereby preventing against confidentiality and integrity attacks. The process 500 may be implemented by one or more computing devices, entities, and/or systems described herein. For example, via the various steps/operations of the process 500, the CFP system 101 may establish trust with a tenant computing entity 102 such that the tenant computing entity 102 may program a cloud programmable logic instance that is associated with the CFP system 101. By doing so, the process 500 improves computer functionality by improving authentication for tenant-side checking of designs for cloud FPGA deployment.

In some embodiments, the process 500 comprises, at operation 502, providing a BI to a tenant computing entity. For example, the CFP system 101 may provide a BI to a tenant computing entity 102. In some embodiments, the BI comprises an executable and one or more design compiling and design checking tools. In some embodiments, the tenant computing entity comprises a TSRoT. In some embodiments, the BI comprises a plurality of acceptable hash states that are associated with the TSRoT. In some embodiments, the TSRoT is configured to terminate execution of the BI based at least in part on the TSRoT comprising a hash state that is not in the plurality of acceptable hash states.

In some embodiments, the process 500 comprises, at operation 504, receiving a certificate chain from the tenant computing entity via the BI. For example, the CFP system 101 may receive a certificate chain from the tenant computing entity 102 via the BI. In some embodiments, a TSRoT certificate and a BI certificate are received.

In some embodiments, the process 500 comprises, at operation 506, validating the certificate chain with a CA. For example, the CFP system 101 may validate the certificate chain with a CA. In some embodiments, the TSRoT certificate and the BI certificate are validated with a CA. For example, the CFP system 101 may validate the TSRoT certificate and the BI certificate with a CA to mitigate “man-in-the-middle” attacks between the CFP system 101 and the TSRoT, particularly of design rules.

In some embodiments, the process 500 comprises, at operation 508, providing a design rule data object to the tenant computing entity via the BI. For example, the CFP system 101 may provide a design rule data object to the tenant computing entity via the BI. In some embodiments, the design rule data object is generated by (i) generating an EDR nonce and (ii) symmetrically encrypting a design rule with the EDR nonce. In some embodiments, an EDR key is generated by asymmetrically encrypting the EDR nonce with a BI public key and a TSRoT public key.

In some embodiments, the process 500 comprises, at operation 510, receiving a secure design rule result data object and an encrypted bitstream. For example, the CFP system 101 may receive a secure design rule result data object and an encrypted bitstream.

In some embodiments, the BI is configured to generate the secure design rule result data object by (i) determining an exclusive or (XOR) of a hash of a design rule result with a hash of the raw bitstream and (ii) asymmetrically encrypting the XOR with a cloud programmable logic provider public key. In some embodiments, the BI is configured to generate the encrypted bitstream by applying a first symmetric encryption on the raw bitstream with the hash of the raw bitstream. In some embodiments, the BI is configured to generate the encrypted bitstream by applying a second symmetric encryption on the first symmetrically encrypted raw bitstream with a programmable logic-side root of trust nonce.

In some embodiments, the design rule result is determined based at least in part on the secure design rule result data object by asymmetrically decrypting the secure design rule result data object with a cloud programmable logic provider private key. In some embodiments, an estimate hash of the raw bitstream is recovered by generating an XOR of the design rule result and a hash of an expected design rule result. In some embodiments, using the programmable logic-side root of trust nonce, the first symmetrically encrypted raw bitstream is recovered by symmetrically decrypting the second symmetrically encrypted raw bitstream with the programmable logic-side root of trust nonce. In some embodiments, using the programmable logic-side root of trust nonce, the raw bitstream is recovered by symmetrically decrypting the recovered first symmetrically encrypted raw bitstream with the estimate hash of the raw bitstream.

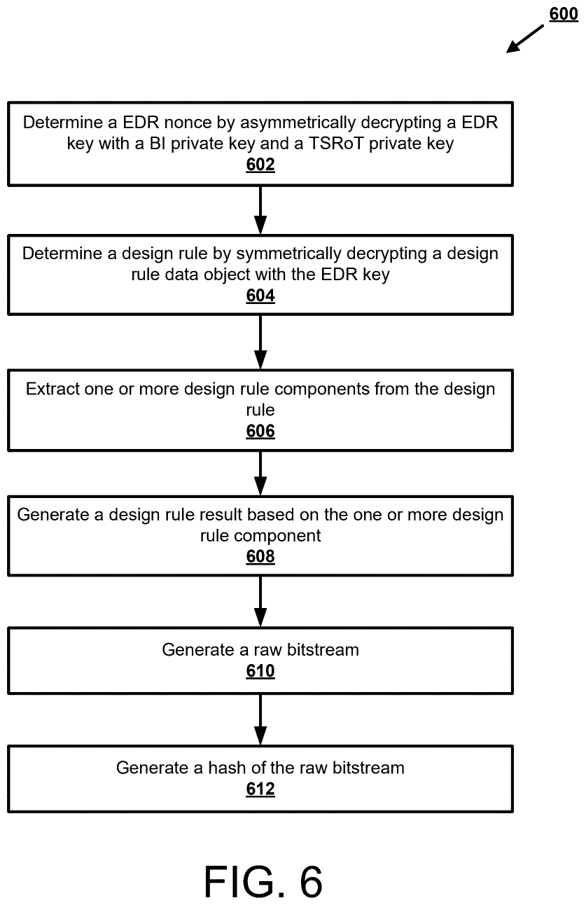

FIG. 6 is a flowchart diagram of an example bitstream encryption process 600 in accordance with some embodiments of the present disclosure. The flowchart diagram depicts an encryption technique for deploying a hardware design on cloud FPGA that provides malicious circuitry detection in the RTL code provided to a BI by a tenant computing entity. The process 600 may be implemented by one or more computing devices, entities, and/or systems described herein.

In some embodiments, the process 600 comprises, at operation 602, determining a EDR nonce by asymmetrically decrypting a EDR key with a BI private key and a TSRoT private key. For example, the CFP system 101 may determine a EDR nonce by asymmetrically decrypting a EDR key with a BI private key and a TSRoT private key.

In some embodiments, the process 600 comprises, at operation 604, determining a design rule by symmetrically decrypting a design rule data object with the EDR key. For example, the CFP system 101 may determine a design rule by symmetrically decrypting a design rule data object with the EDR key.

In some embodiments, the process 600 comprises, at operation 606, extracting one or more design rule components from the design rule. For example, the CFP system 101 may extract one or more design rule components from the design rule.

In some embodiments, the process 600 comprises, at operation 608, generating a design rule result based at least in part on the one or more design rule components. For example, the CFP system 101 may generate a design rule result based at least in part on the one or more design rule components.

In some embodiments, the process 600 comprises, at operation 610, generating a raw bitstream. For example, the CFP system 101 may generate a raw bitstream.

In some embodiments, the process 600 comprises, at operation 612, generating a hash of the raw bitstream. For example, the CFP system 101 may generate a hash of the raw bitstream.

Returning to FIG. 5, in some embodiments, the process 500 comprises, at operation 512, determining a match of the secure design rule result data object with the design rule data object. For example, the CFP system 101 may determine a match of the secure design rule result data object with the design rule data object. In some embodiments, determining the match further comprises comparing a hash of the recovered raw bitstream with the estimate hash of the raw bitstream.

In some embodiments, the process 500 comprises, at operation 514, programming a cloud programmable logic instance with a decryption of the encrypted bitstream based at least in part on the match. For example, the CFP system 101 may program a cloud programmable logic instance with a decryption of the encrypted bitstream based at least in part on the match. In some embodiments, the cloud programmable logic instance comprises a cloud field-programmable gate array.

FIG. 5 and FIG. 6 illustrate example processes 500 and 600, respectively for explanatory purposes. Although the example processes 500 and 600 depict particular sequences of steps/operations, the sequences may be altered without departing from the scope of the present disclosure. For example, some of the steps/operations depicted may be performed in parallel or in a different sequence that does not materially impact the function of the processes 500 and/or 600. In other examples, different components of an example device or system that implements the processes 500 and/or 600 may perform functions at substantially the same time or in a specific sequence.

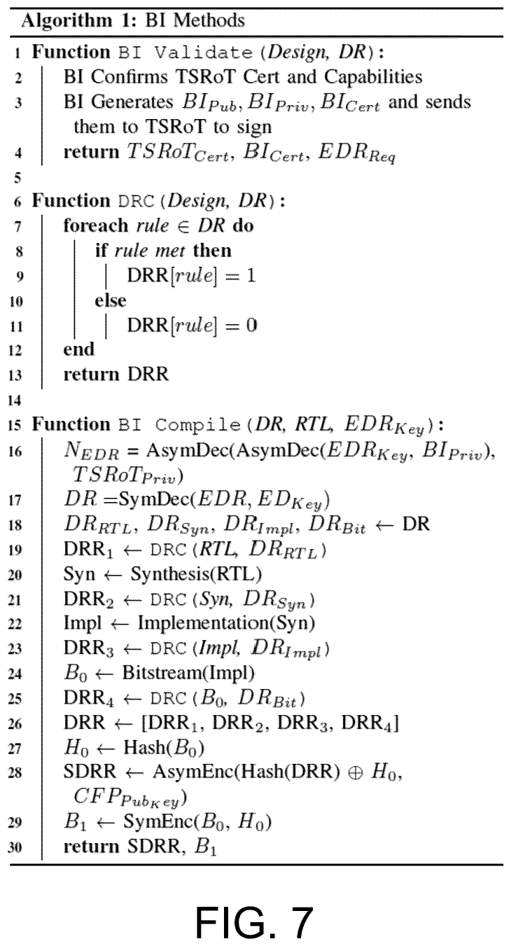

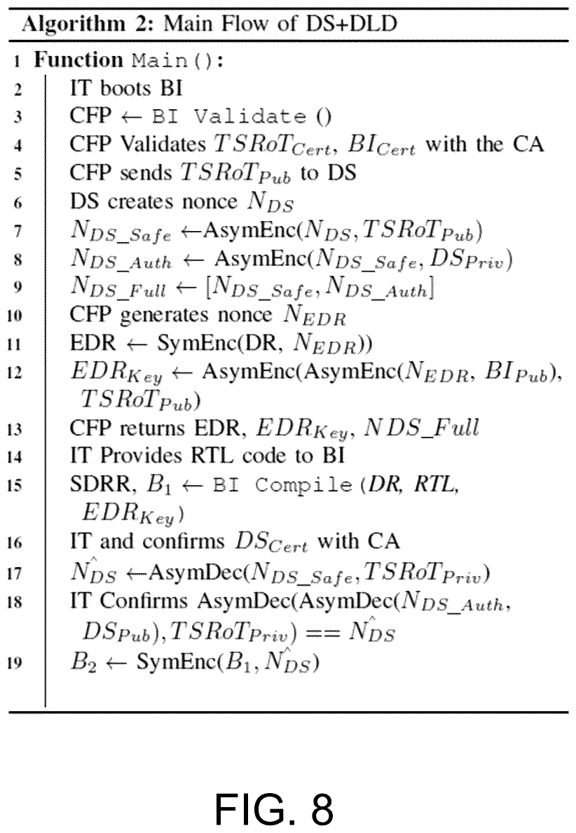

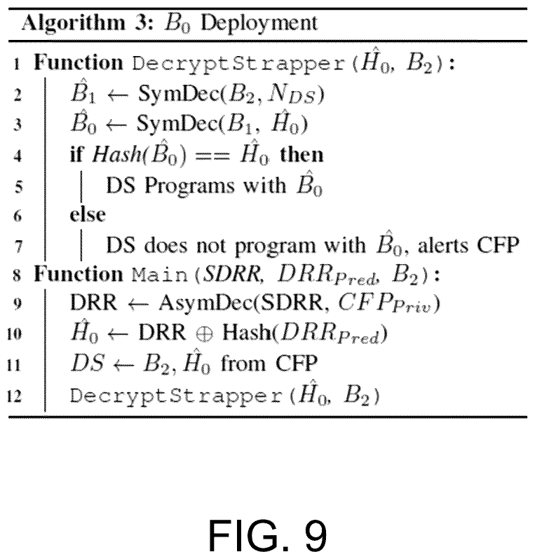

Exemplary algorithms for performing operations of the disclosed embodiments may be further understood with reference to FIG. 7, FIG. 8, and FIG. 9.

FIG. 7 is an operational example of algorithms for performing BI methods in accordance with some embodiments of the present disclosure.

FIG. 8 is an operational example of an algorithm for implementing a DecryptStrapper and DLD in accordance with some embodiments of the present disclosure.

FIG. 9 is an operational example of an algorithm for deploying a raw bitstream to cloud programmable logic in accordance with some embodiments of the present disclosure.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A computer-implemented method of protecting a hardware design against confidentiality and integrity attacks, the computer-implemented method comprising:
providing, by one or more processors, a bootable image (BI) to a tenant computing entity;
receiving, by the one or more processors, a certificate chain originating from the tenant computing entity via the BI;
validating, by the one or more processors, the certificate chain with a certificate authority;
providing, by the one or more processors, a design rule data object to the tenant computing entity via the BI;
receiving, by the one or more processors, a secure design rule result data object and an encrypted bitstream;
determining, by the one or more processors, a match of the secure design rule result data object with the design rule data object; and
programming, by the one or more processors, a cloud programmable logic instance with a decryption of the encrypted bitstream based at least in part on the match.

2. The computer-implemented method of claim 1, wherein the BI comprises an executable and one or more design compiling and design checking tools.

3. The computer-implemented method of claim 1, wherein the tenant computing entity comprises a tenant-side root of trust (TSRoT).

4. The computer-implemented method of claim 3, wherein the BI comprises a plurality of acceptable hash states that are associated with the TSRoT.

5. The computer-implemented method of claim 4, wherein the TSRoT is configured to terminate execution of the BI based at least in part on the TSRoT comprising a hash state that is not in the plurality of acceptable hash states.

6. The computer-implemented method of claim 1, wherein the cloud programmable logic instance comprises a cloud field-programmable gate array.

7. The computer-implemented method of claim 1 further comprising:
receiving a TSRoT certificate and a BI certificate; and
validating the TSRoT certificate and the BI certificate with a certificate authority.

8. The computer-implemented method of claim 1 further comprising generating the design rule data object by:
generating an encrypted design rule (EDR) nonce; and
symmetrically encrypting a design rule with the EDR nonce.

9. The computer-implemented method of claim 8 further comprising generating an EDR key by asymmetrically encrypting the EDR nonce with a BI public key and a TSRoT public key.

10. The computer-implemented method of claim 9 wherein the BI is configured to generate the encrypted bitstream by:
determining the EDR nonce by asymmetrically decrypting the EDR key with a BI private key and a TSRoT private key;
determining a design rule by symmetrically decrypting the design rule data object with the EDR key;
extracting one or more design rule components from the design rule;
generating a design rule result based at least in part on the one or more design rule components;
generating a raw bitstream;
generating a hash of the raw bitstream.

11. The computer-implemented method of claim 10, wherein the BI is configured to generate the secure design rule result data object by:
determining an exclusive or (XOR) operation result of a hash of the design rule result with a hash of the raw bitstream; and
asymmetrically encrypting the XOR operation result with a cloud programmable logic provider public key.

12. The computer-implemented method of claim 11, wherein the BI is configured to generate the encrypted bitstream by applying a first symmetric encryption on the raw bitstream with the hash of the raw bitstream.

13. The computer-implemented method of claim 12, wherein the BI is configured to generate the encrypted bitstream by applying a second symmetric encryption on the first symmetrically encrypted raw bitstream with a programmable logic-side root of trust nonce.

14. The computer-implemented method of claim 13 further comprising determining the design rule result based at least in part on the secure design rule result data object by asymmetrically decrypting the secure design rule result data object with a cloud programmable logic provider private key.

15. The computer-implemented method of claim 14 further comprising recovering an estimate hash of the raw bitstream by generating an XOR of the design rule result and a hash of an expected design rule result.

16. The computer-implemented method of claim 15 further comprising recovering, using the programmable logic-side root of trust nonce, the first symmetrically encrypted raw bitstream by symmetrically decrypting the second symmetrically encrypted raw bitstream with the programmable logic-side root of trust nonce.

17. The computer-implemented method of claim 16 further comprising recovering, using the programmable logic-side root of trust nonce, the raw bitstream by symmetrically decrypting the recovered first symmetrically encrypted raw bitstream with the estimate hash of the raw bitstream.

18. The computer-implemented method of claim 17, wherein determining the match comprises comparing a hash of the recovered raw bitstream with the estimate hash of the raw bitstream.

19. A system comprising:
one or more processors and at least one memory storing processor-executable instructions that, when executed by any of the one or more processors, causes the one or more processors to perform operations comprising:
providing a bootable image (BI) to a tenant computing entity;
receiving a certificate chain originating from the tenant computing entity via the BI;
validating the certificate chain with a certificate authority;
providing a design rule data object to the tenant computing entity via the BI;
receiving a secure design rule result data object and an encrypted bitstream;
determining a match of secure design rule result data object with the design rule data object; and
programming a cloud programmable logic instance with a decryption of the encrypted bitstream based at least in part on the match.

20. One or more non-transitory computer-readable storage media including instructions that, when executed by one or more processors, cause the one or more processors to perform operations comprising:
providing a bootable image (BI) to a tenant computing entity;
receiving a certificate chain originating from the tenant computing entity via the BI;
validating the certificate chain with a certificate authority;
providing a design rule data object to the tenant computing entity via the BI;
receiving a secure design rule result data object and an encrypted bitstream;
determining a match of the secure design rule result data object with the design rule data object; and
programming a cloud programmable logic instance with a decryption of the encrypted bitstream based at least in part on the match.
